(19) United States
(12) Patent Application Publication
(10) Pub. No.: US 2018/0104876 A1
(43) Pub. Date: Apr. 19, 2018

(54) METHOD FOR THE EXTRUSION BLOW MOULDING OF A CONTAINER OF THERMOPLASTIC MATERIAL AND EXTRUSION BLOW-MOULDED CONTAINER

(71) Applicant: KAUTEX TEXTRON GMBH & CO. KG, Bonn (DE)

(72) Inventor: Dieter SCHMITZ, Bonn (DE)

(21) Appl. No.: 15/552,151

(22) PCT Filed: Feb. 16, 2016
(86) PCT No.: PCT/EP2016/053284

§ 371 Date: Jan. 2, 2018

(30) Foreign Application Priority Data
Feb. 18, 2015 (DE) 10 2015 202 940.9

(51) Int. Cl. B29C 47/00; B29C 49/42; B29C 49/04; B29C 51/32; B29C 51/12; B29C 49/22

(52) U.S. Cl. CPC B29C 47/0054; B29C 49/4273; B29C 49/04; B29C 2049/2039; B29C 51/12; B29C 49/22; B29C 51/32

(57) ABSTRACT

The invention relates to a method for extrusion blow-molding a container from a thermoplastics material, having at least one conduit through a wall of the container, wherein the method comprises providing an insert part from a thermoplastics material, said insert part having a conduit; incorporating a preform from a thermoplastics material into a blow-molding tool having a mold cavity which defines the contour of the container; molding the preform within the mold cavity, wherein the preform on the mold cavity side encloses the insert part and is welded to the insert part; removing the container from the blow-molding tool; and producing an opening in the wall of the container by means of a tool which is guided from the outside through the conduit of the insert part. The invention furthermore relates to an extrusion blow-molded container from a thermoplastics material.

### FIELD

The invention relates to a method for extrusion blow-molding a container from a thermoplastics material, having at least one conduit through a wall of the container, and to an extrusion blow-molded container from a thermoplastics material, preferably made according to the method according to the invention.

### BACKGROUND

Extrusion blow-molded containers from a thermoplastics material in the context of the invention are particularly but not exclusively fuel containers for motor vehicles, screen wash fluid containers, oil containers, auxiliary fluid containers or additive containers for motor vehicles. Containers of the type mentioned at the outset are often produced by extrusion blow-molding, wherein HDPE (high density polyethylene) is particularly suitable for producing extrusion blow-molded containers.

In the production of large casks such as drums or IBCs (intermediate bulk containers) it is known in principle for grip elements, threaded inserts, or other accessory parts, to be fastened to the containers during the production of the latter. As is known, HDPE is a thermoplastics material which under permanent compressive stress regains plasticity and has a tendency to creep. There is therefore in principle the requirement for specific highly stressed accessory parts, or other parts such as grip elements or fastening eyelets, to be produced from a high-strength thermoplastics material. Such add-on parts are often produced by injection-molding filled thermoplastics material, said add-on parts in the production of the extrusion blow-molded container then being “insertion blown”. This means that the respective parts are placed as insert parts into the tool or in the cavity, respectively, of the blow-molding tool. As the container body is being molded from HDPE, the container body connects to the insert parts either in a materially-integral manner or a form-fitting manner

It is an inherent disadvantage of extrusion blow-molding that components having pronounced undercuts are not demoldable or not readily demoldable from the blow-molding tool, which is why the use of insert parts in blow-molding tools has a comparatively long tradition.

A method for producing a container by extrusion blow-molding while using insert parts in the blow-molding tool is described for example in U.S. Pat. No. 6,262,325 B1. The insert parts there are used for forming fastening eyelets and threaded blind holes on the container.

In so far as the placing of openings and conduits on extrusion blow-molded containers is concerned, it has proven successful in the case of conventional extrusion blow-molding, that is to say in the extrusion blow-molding of tubular preforms, for such openings to be provided in the region of the separation plane of the blow-molding tool, as far as possible where a blow mandrel is inserted into the preform that is disposed within the mold cavity of the blow-molding tool. An opening which optionally has been calibrated by means of a blow mandrel is then reamed at a later stage. U.S. Pat. No. 6,262,325 B1 thus describes such a container in which the pouring opening has been produced in the manner described above.

For example, in the case of fuel containers for motor vehicles it is necessary under certain conditions for a plurality of openings to be provided in the container wall, for example for routing ventilation entry and exit connectors, or for routing connector nipples for ventilation entry and exit lines, or else for fuel lines.

In the case of such containers, openings in the container wall are usually reamed once the container has been completely finished; nipples and/or valves are then inserted into the openings and welded or adhesively bonded to the container wall. It is also known for connector elements in two parts, which are sealed in relation to the container wall by optionally interdisposing elastic sealing means, to be provided.

Since modern fuel containers are to some extent composed of plastics materials that are co-extruded in multiple layers, barrier layers for hydrocarbons being embedded in the wall of said plastics materials, the subsequent incorporation of openings into the container wall requires the barrier layers to be compromised such that potential leakage paths are created in the region where connector pieces and nipples are welded to the container wall.

Several design proposals and method variants are known in which the object is for conduits, in particular line conduits, which have a diffusion tightness in relation to volatile hydrocarbons that is as high as possible to be provided through the container wall.

A method for producing an extrusion blow-molded fuel container in which a projecting protuberance on the tool side is generated in the container wall when molding the container wall is thus known from EP 2 777 910 A1, for example. A profiled connector feature of a nipple is inserted into this protuberance from the inside; thereafter the preform in the blow-molding tool in the region of the protuberance is constricted by means of a plurality of slides that are disposed in the blow-molding tool such that said preform comes to bear on the external profile of the nipple and with the latter establishes a form-fitting and materially-integral connection. The nipple in this region is provided with a respective ribbed profile. Moreover, the nipple is welded to the preform when the slides are converged. Once the container has been removed from the blow-molding tool, the container wall in the region of the protuberance is cut open such that the nipple can be connected from the outside.

The method according to EP 2 777 910 A1 inevitably requires that the nipple or the connector port, respectively, is inserted into the protuberance of the preform from inside within the mold cavity. If at all, such a manipulation in the case of conventional extrusion blow-molding from a tubular preform can be carried out only with extreme complexity.

The method according to EP 2 777 910 A1 is therefore limited substantially to the so-called “twin-sheet blow-molding” method in which the tubular preform is cut into two web-shaped sheets which within the blow-molding tool are then placed on the cavities of the blow-mold halves. In the case of this method the preforms are temporarily accessible on the mold cavity side.

This method moreover requires a comparatively complex technology in terms of the slides in the blow-molding tool.

A method in which an opening in a wall of the container is generated by means of an insert part which has a needle tip which penetrates the wall of the container when the latter is being molded within the mold cavity is known from U.S. Pat. No. 5,103,865. The insert part is configured as a valve housing for a venting valve, and that part of the latter that plunges into the container volume is optimized with a view to having to penetrate the wall of the container. In the case of such an insert part it is thus impossible for a conduit that at the end side is substantially open and cylindrical to be generated, since the insert part first of all has to displace the penetrated material of the preform.

A method for extrusion blow-molding a container from a thermoplastics material and an extrusion blow-molded container are known from US 2009/101642 A1.

Prior art can furthermore be derived from documents DE 22 10 693 A1 and DE 28 25 097 A1.

### SUMMARY

The invention is based on the object of providing a particularly simple method for extrusion blow-molding a container from a thermoplastics material, having at least one conduit through a wall of the container, which method in particular is also capable of being carried out as a conventional extrusion blow-molding method using a tubular preform.

The object is first achieved by a method for extrusion blow-molding a container from a thermoplastics material, having at least one conduit through a wall of the container, said method comprising the following method steps:
providing an insert part from a thermoplastics material, said insert part having a conduit;
incorporating a preform from a thermoplastics material into a blow-molding tool having a mold cavity which defines the contour of the container;
molding the preform within the mold cavity, wherein the preform on the mold cavity side encloses the insert part and is welded to the insert part;
producing an opening in the wall of the container by means of a tool which is guided from the outside through the conduit of the insert part.

“Mold cavity side” in the context of the present invention is to be understood as that side of the wall of the container which faces the interior of the mold cavity, whereas “tool side” in the context of the present invention is to be understood as that side of the wall of the container or of the preform that faces the cavity of the blow-molding tool, or that during molding bears on a face of the blow-molding tool, respectively.

A conduit in the context of this invention is a continuous opening in the wall of the container by way of which a fluid communication is establishable with a volume that is enclosed by the container. The conduit can be configured in the form of a cylindrical duct which is open on both sides. The duct can have an internal shell area that is smooth-walled or profiled.

The method according to the present invention is in particular provided as an extrusion blow-molding method in the conventional sense, that is to say that the method comprises extruding and providing a tubular preform from a plasticized thermoplastics material.

It can be provided in the case of the method that a tubular preform from a plasticized thermoplastics material is extruded in the direction of gravity above an initially opened two-part blow-molding tool. A two-part blow-molding tool is to be understood substantially as a blow-molding tool having two blow-mold halves which are disposed in a known manner on mold clamping plates of a closing frame.

Each of the mold halves can have one cavity, wherein the cavities of the mold halves in the case of the closed blow-molding tool define a mold cavity which corresponds to the external contour of the container to be made.

Each of the mold halves can have a plurality of inherent parts, in particular also slides or the like.

At least one clearance for receiving the insert part according to the invention can be provided in at least one of the cavities.

In the simplest case, an insert part in the context of the present invention can be a sleeve, a bush, or the like. However, the insert part can also have a more complicated design, for example in the form of a nipple having at least one plug-fit profile.

In the case of the method according to the invention, the preform encloses the insert part on the mold-cavity side preferably such that the preform or the later wall of the container, respectively, from a thermoplastics material first closes the preferably cylindrical conduit as defined by the insert part on the mold-cavity side in the manner of a blind hole, wherein this part of the wall of the container is opened from the outside by means of a further tool. From the outside in this context means either following the removal of the container from the blow-molding tool, or within the blow-molding tool on the mold-cavity side, that is to say by means of a blow mandrel that is inserted into the preform, for example.

The method according to the invention has the advantage that the former as compared to the known methods is capable of being carried out in a relatively simple manner, and that by means of the insert part an opening that is true-to-size and already calibrated is provided in the wall of the container.

As has been mentioned at the outset, the insert part can be configured as a simple bush into which, for example, a connector port, a nipple, a valve, or a fastening element for an installation part, for example for a wash plate element, is insertable in a sealed manner; alternatively, the insert part can be configured on the external side, that is to say on the tool side, as a nipple having a connector profile, for example. Finally, it is possible for the insert part to also be configured as a so-called double nipple having two connector profiles, for example in the form of pine-tree profiles.

The insert part is preferably inserted into a clearance that is provided therefore in a cavity of the blow-molding tool. The insert part herein, prior to being inserted into the clearance of the cavity of the blow-molding tool, is preferably heated or preheated, respectively, for example by means of an infrared radiator. Incorporating the preform from a thermoplastics material into the blow-molding tool is performed thereafter. The weldability of the insert part to the still warm plastic preform is improved on account of the insert part being pre-warmed or pre-heated.

In one preferred variant of the method according to the invention, the insert part comprises a first and a second thermoplastics material, wherein the first thermoplastics material in terms of weldability is compatible with the thermoplastics material of the wall of the container. The insert part can be configured as a so-called multi-component injection-molded part, for example, and have a support element from polyamide and at least one external layer from LDPE or HDPE, for example. The support element imparts the respective strength and dimensional stability to the insert part.

The second thermoplastics material of the insert part can be specified such, for example, that the former is not weldable to the wall of the container.

Welding in the context of the present invention is to be understood as the mutual molecular penetration of the elements to be mutually welded, this being achieved on account of pressure and temperature, wherein the plastics materials to be welded have to have similar molecular properties in order for such weldability to be guaranteed. For example, polyolefins are typically interweldable, whereas polyolefins and polyamides are typically not interweldable.

Opening the container wall or the conduit, respectively, after the removal of the container from the blow-molding tool can be performed by means of a hot mandrel, for example, this having the advantage that any material that is removed from the container wall does not migrate into the volume of the container.

Alternatively, it can be provided for the opening in the wall of the container to be milled or reamed.

In one expedient variant of the method according to the invention it is provided that a bush having an encircling collar is used as the insert part, wherein the collar encloses or delimits, respectively, a port of the conduit.

It is particularly advantageous for the collar to have a width which corresponds to at least the depth of the conduit. A collar that is dimensioned so as to be comparatively wide has the particular advantage that the collar offers an enlarged face for welding. The larger the area in which the collar is welded to the wall of the container, the longer the potential diffusion path of hydrocarbons when the container is to be configured as a fuel container, for example.

The collar is preferably provided on that side of the conduit that faces the mold cavity.

For example, the collar can enclose a port of the conduit that faces the container internal side and be angled in the direction toward the container external side such that the insert part forms a trough on the container external side in the wall of the container. In this way, the contact face between the insert part and the wall of the container is enlarged, on account of which a potential leakage path is also extended. Moreover, a connector to the conduit can be integrated in the container external face in this way, which can be potentially advantageous with a view to the installation situation of the container, for example in a motor vehicle.

The invention furthermore relates to an extrusion blow-molded container from a thermoplastics material, having a conduit in a wall of the container, wherein the conduit is formed by an insert part which is partially enclosed by the wall of the container and is welded to said wall, wherein the insert part forms a conduit and has an encircling collar, and wherein the insert part comprises a first and a second thermoplastics material, wherein the first thermoplastics material is welded to the wall of the container. The first thermoplastics material is preferably dissimilar to the second thermoplastics material.

The insert part can be provided as a cylindrical sleeve having an encircling collar, for example, which can surround a port of the conduit on the container internal side and/or the container external side.

In the case of one variant of the container according to the invention it is provided that the collar encloses a port that faces a container internal side of the conduit and is angled in the direction of the container external side such that the insert part forms a preferably funnel-shaped trough on the container external side.

Of course, the collar can also enclose a port of the conduit that faces a container external side and can be inserted without any excess length in the external side of the container wall.

In the case of one variant of the extrusion blow-molded container according to the invention, the conduit is delimited by a smooth-walled internal shell area.

The insert part can be configured as a bush or a sleeve, for example, which both on the external side as well as on the internal side comprises an HDPE and comprises a support element from polyamide.

In the case of a further variant of the extrusion blow-molded container according to the invention, the insert part can be configured as a sleeve or a bush which on the external side comprises an HDPE and on the internal side has a shell area from an LDPE, for example from a maleic anhydride-modified LDPE. The LDPE shell area on the internal side of the conduit herein can be configured as an adhesion-promoting layer for a connector port that is to be welded into the conduit, for example.

In one variant of the container according to the invention it is provided that the collar is welded to the wall of the container in a fully planar manner, and that the width of the collar is at least as large as the depth of the conduit.

The depth of the trough expediently corresponds to at least the depth of the conduit such that the port of the conduit on the container external side aligns with at least the external wall of the container.

The conduit can have a connector port or a nipple, for example, which is either welded into the conduit or is sealed in the conduit by means of O-ring seals.

The extrusion blow-molded container of the type described above has preferably been obtained by the method of the invention.

### BRIEF DESCRIPTION OF THE DRAWINGS

The invention will be explained hereunder by means of an exemplary embodiment that is illustrated in the drawings.

In the drawings:

FIG. 1 shows a partial section through the wall of an extrusion blow-molded container according to the invention, as per a first variant; and

FIG. 2 shows a section through the wall of an extrusion blow-molded container according to the invention, prior to the opening in the wall of the container having been opened outward by means of a tool, that is to say immediately after the removal of the container from a blow-molding tool.

### DETAILED DESCRIPTION

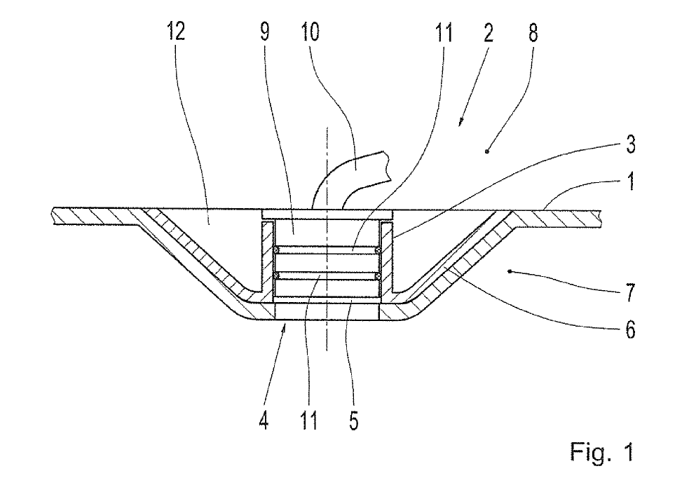

For the sake of simplification, only part of a wall 1 of a container 2 according to the invention is illustrated in FIG. 1.

The container 2 is produced by extrusion blow-molding from a thermoplastics material. To this end a preform in the form of a preferably multi-layered tubular extrudate can be provided by means of a conventional extruder head (not shown), for example. The extruder head can be disposed above a blow-molding tool (not illustrated), for example, the latter potentially having two blow-mold halves, for example, which in a known manner are disposed on mold clamping plates of a closing frame. The blow-mold halves can be opened and closed by way of the mold clamping plates. The blow-mold halves in each case have at least one cavity, the latter in the case of the closed blow-molding tool forming a mold cavity of which the contour corresponds to the external design of the container that is to be produced by extrusion blow-molding.

The tubular preform in the direction of gravity is ejected from the extruder head in either a continuous or a discontinuous manner and is cut to length between the opened parts of the blow-molding tool, the blow-molding tool thereupon closing about the tubular preform. Widening of the preform in the mold cavity of the blow-molding tool is thereupon performed while using negative pressure within the mold cavity and/or while using positive pressure by including a blow needle in the preform.

The method according to the invention now provides that an insert part 3 is incorporated in at least one cavity of at least one blow-mold half prior to the tubular preform being moved into the blow-molding tool.

FIG. 1 shows the insert part 3 in the wall 1 of the finished container 2.

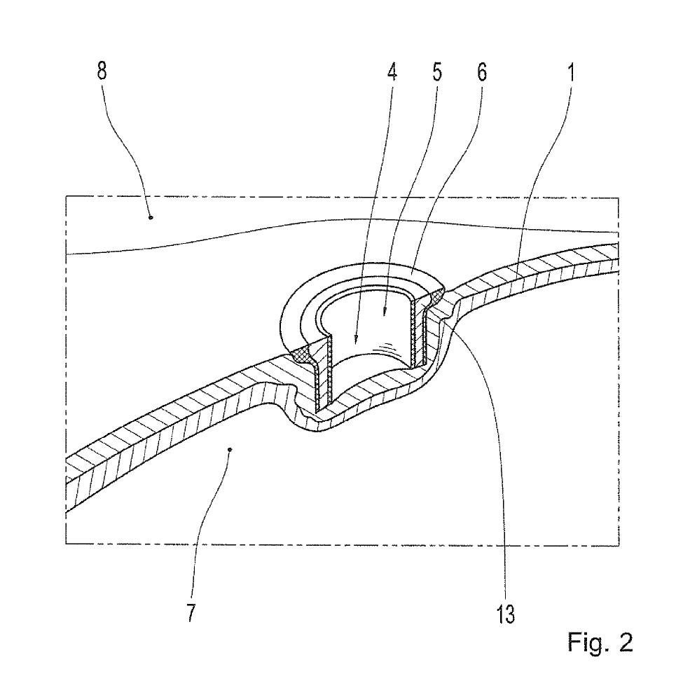

The wall 1 of the container 2 can be composed of a single-layered or a multi-layered thermoplastics material. For the sake of simplification, the wall 1 of the container 2 in FIG. 1 is illustrated as being single-layered, whereas the wall 1 of the container 2 in FIG. 2 is illustrated as being multi-layered. The wall 1 of the container in FIG. 2 comprises two layers, said container potentially having up to six different layers; for example, said container can be configured as a co-extrudate based on HDPE having a barrier layer from EVOH.

The insert part 3 at the beginning of a blowing cycle is inserted into a correspondingly configured depression or receptacle in a cavity of the blow-molding tool, for example by means of a handling robot.

Subsequently or during the above, the tubular extrudate or the preform, respectively, is moved between the opened parts of the blow-molding tool. The blow-molding tool closes about the preform, the preform thereupon being widened within the mold cavity that is formed by the cavities. The preform herein bears on the mold-cavity side parts of the insert part and connects to the latter.

For example, the insert part 3 has the configuration illustrated in FIG. 1, having a central and cylindrical conduit 4 and an encircling collar 6 which is contiguous to a port 5 of the conduit 4. The collar 6 in the arrangement illustrated in FIG. 1 faces a container internal side 7 and is welded across a large area to the wall 1 of the container 2. A connection stopper 9 having a line connector 10 is inserted into the conduit 4 on a container external side 8. The connection stopper 9 can be welded or adhesively bonded within the conduit 4; in the case of the exemplary embodiment illustrated in FIG. 1, the connection stopper 9 is inserted in a releasable manner into the conduit 4 and by means of O-rings 11 is sealed in relation to an internal shell area of the conduit 4.

The collar 6 is angled in the direction toward the container external side 8 and in relation to a longitudinal central axis of the conduit 4 forms an acute angle. The insert part 3 by virtue of this design embodiment of the insert part 3 is sunk into the container 2, or the insert part 3 together with the wall 1 of the container 2 forms a trough 12, respectively. The trough 12 has a depth which corresponds approximately to the depth or length, respectively, of the conduit 4 such that the port of the conduit 4 that faces the container external side 8 aligns approximately with the remaining face of the wall 1 of the container 2.

As has already been mentioned above, the insert part 3 can be configured as an injection-molded bi-component part, wherein the insert part 3 illustrated in FIG. 2 on that face of the collar 6 that faces the wall 1 and the container internal side 7 comprises an LDPE or an HDPE, for example, and the remainder of the body of the insert part 3 can be composed of a polyamide or another thermoplastics material.

In principle, the insert part 3 can also be composed of a single injection-molded thermoplastics material which has properties other than those of the thermoplastics material of the container 2 or of the wall 1 of the container 2, respectively.

An alternative design embodiment of the container according to the invention is illustrated in FIG. 2, wherein the conduit 4 in the case of the container illustrated in FIG. 2 has not yet been opened. The figure shows a section through the wall of the container 2 immediately upon removal of the container 2 from the blow-molding tool, wherein like in FIG. 1 the container internal side is identified by the reference sign 7 and the container external side is identified by the reference sign 8.

The insert part 3 is configured substantially as a bush which likewise has an encircling collar 6 which surrounds the port 5 of the conduit 4 on the container external side 8. The collar 6 is inserted completely in the container external side 8 and aligns with the latter.

The insert part 3 on the container internal side 7 is closed by the wall 1 of the container.

The insert part 3 likewise has a cylindrical conduit 4 that is smooth-walled on the inside, wherein the internal shell area of the conduit 4 is formed by an LDPE layer, and the external shell area of the insert part 3, which is welded to the wall 1 of the container 2, is formed by an HDPE layer. The insert part 3 furthermore comprises a support element 13 which can be composed of polyamide, for example.

### LIST OF REFERENCE SIGNS

1 Wall
2 Container
3 Insert part
4 Conduit
5 Port
6 Collar
7 Container internal side
8 Container external side
9 Connection stopper
10 Line connector
11 O-rings
12 Trough
13 Support element

What is claimed is:

1-16. (canceled)

17. A method for extrusion blow-molding a container formed of a thermoplastic material, having at least one conduit through a wall of the container, said method comprising:
providing a insert part formed of at least one thermoplastic material, said insert part having a conduit;
incorporating a preform formed of a thermoplastic material into a blow-molding tool having a mold cavity which defines a contour of the container;
molding the preform within the mold cavity to form the wall of the container, wherein the preform has a mold cavity side, and on the mold cavity side encloses the insert part and is welded to the insert part;
producing an opening in the wall of the container by a tool which is guided from outside the container through the conduit of the insert part; and
wherein the insert part comprises a first thermoplastic material and a second thermoplastic material, wherein the first thermoplastic material of the insert part is weldable with the thermoplastic material of the preform forming the wall of the container.

18. The method as claimed in claim 17, wherein the second thermoplastic material of the insert part is not weldable to the thermoplastic material of the preform forming the wall of the container.

19. The method as claimed in claim 17, wherein producing the opening in the wall of the container comprises melting the wall with a hot mandrel.

20. The method as claimed in claim 17, wherein producing the opening in the wall of the container comprises at least one of milling and reaming the wall of the container.

21. The method as claimed in claim 17, wherein the insert part is configured as an injection-molded multi-component part.

22. The method as claimed in claim 17, wherein the insert part comprises a bush having an encircling collar, and wherein the collar encloses a port of the conduit.

23. The method as claimed in claim 22, wherein the collar has a width which corresponds to at least a depth of the conduit.

24. The method as claimed in claim 22, wherein the port of the conduit faces an internal side of the container, and is angled in a direction toward an external side of the container such that the insert part forms a trough on the external side of the container in the wall of the container.

25. An extrusion blow-molded container comprising:
the extrusion blow-molded container formed of thermoplastic material, and having a conduit in a wall of the container,
wherein an insert part is enclosed by the wall of the container and is welded to the wall of the container,
wherein the insert part provides the conduit and has an encircling collar,
wherein the insert part comprises a first thermoplastic material and a second thermoplastic material, and
wherein the first thermoplastic material of the insert part is welded to the wall of the container.

26. The extrusion blow-molded container as claimed in claim 25, wherein the collar encloses a port of the conduit that faces an internal side of the container, and is angled in a direction toward an external side of the container such that the insert part forms a trough on the external side of the container n the wall of the container.

27. The extrusion blow-molded container as claimed in claim 25, wherein the conduit has a smooth inner wall.

28. The extrusion blow-molded container as claimed in claim 25, wherein the collar is welded to the wall of the container in a fully planar manner, and a width of the collar is at least as large as a depth of the conduit.

29. The extrusion blow-molded container as claimed in claim 26, wherein a depth of the trough corresponds to at least a depth of the conduit.

30. The extrusion blow-molded container as claimed in claim 25, wherein the conduit receives at least one of a connector port, a nipple, a valve, and a fastening element for an installation part of the container.
